(19) United States
(12) Patent Application Publication
(10) Pub. No.: US 2011/0085474 A1
(43) Pub. Date: Apr. 14, 2011

(54) TERMINAL DEVICE, SIGNATURE GENERATION SERVER, SIMPLE ID MANAGEMENT SYSTEM, SIMPLE ID MANAGEMENT METHOD, AND PROGRAM

(76) Inventor: Ryoki HONJO, Kanagawa (JP)

(21) Appl. No.: 12/880,328

(22) Filed: Sep. 13, 2010

(30) Foreign Application Priority Data
Oct. 9, 2009 (JP) P2009-235469

(51) Int. Cl. H04L 12/16

(52) U.S. Cl. 370/271

(57) ABSTRACT

Provided is a terminal device including a simple ID registration unit that registers, in first auxiliary information which is managed in association with a user ID for specifying an individual user and which is made a search target at a time of searching for the user ID, a simple ID expressed by a combination of numbers or of a number and a specific symbol, and a signature registration unit that registers, in second auxiliary information which is managed in association with the first auxiliary information or the user ID and which is not made the search target, an electronic signature obtained, by using a signature key, from ID information including the user ID and the simple ID.

### BACKGROUND OF THE INVENTION

1. Field of the Invention

The present invention relates to a terminal device, a signature generation server, a simple ID management system, a simple ID management method, and a program.

2. Description of the Related Art

With the progress in information processing technology and information communication technology, various services have come to be provided through the use of a wide area network such as the Internet. Among the services, a voice communication service (hereinafter, IP telephony service) using the wide area network is particularly gaining attention. In the past, the voice communication service was provided by using infrastructure, such as telephone lines, provided by a telephone office. On the other hand, the IP telephony service is provided by mainly using the wide area network. Accordingly, in the case of the IP telephony service, there is an advantage that, although there is a cost for using the wide area network, a call charge can be made low.

The IP telephony service includes a method of communicating by using a general telephone connected to an IP-telephone compatible modem (hereinafter, telephone method) and a method of communicating by using IP telephony software installed on a personal computer (hereinafter, PC) (hereinafter, software method). The main difference between the methods lies in the difference between user interfaces. In the case of the telephone method, a user can communicate by using a general telephone without being aware that it is an IP telephony service. On the other hand, in the case of the software method, a user has to activate IP telephone software or input a user ID or a password for using the IP telephony service.

However, in the case of the software method, there is an advantage that the voice communication service can be used with not only a telephone but any electronic device provided with IP telephony software and connected to the wide area network. For example, logically, the IP telephony service can be used by using a PC, a mobile terminal, a digital television or the like. However, when an IP telephony service of the software method is to be used with an electronic device not provided with a keyboard that allows easy input of alphanumeric characters and symbols (hereinafter, full keyboard), significant inconvenience is caused at the time of inputting the user ID or the like. Methods of aiding input with respect to the IP telephony service of the software method are described in JP-A-2008-153757, JP-A-2008-153758 and JP-A-2008-153759.

For example, JP-A-2008-153757 discloses a technology for setting a callee-user name for an IP telephony service by adding a specific character string to a landline number of the callee and, depending on the state of the callee, automatically switching to use the landline number or to use the callee-user name. Also, JP-A-2008-153758 discloses a technology for associating a callee-user name to a callee selection button in advance and automatically connecting to a callee when a user presses the callee selection button. Furthermore, JP-A-2008-153759 discloses a technology for using an extension number by adding the extension number to a specific callee-user name, in a case an extension number is input.

### SUMMARY OF THE INVENTION

However, the technologies of JP-A-2008-153757 and JP-A-2008-153759 are for adding a character string to an existing callee-user name, and are not for aiding input of the existing callee-user name. Also, usage of the technology described in JP-A-2008-153758 takes as its premise usage of special hardware assigning a callee-user name to a callee selection button. Therefore, the advantage of the software method described above will be lost. Also, since the number of callees that can be selected is limited to the number of the callee selection buttons, an inconvenience will be caused in a case an arbitrary callee is desired to be selected. Furthermore, when adopting the technologies of the respective patent documents described above, a callee-user who has already acquired a callee-user name or the like will be asked to change the callee-user name or the like.

For these reasons, a technology is desired that enables easy input, by using an electronic device not provided with the full keyboard, of information such as a callee-user name that is to be input at the time of using the IP telephony service of the software method. For example, a method of easily specifying a callee by using a remote control that is frequently used as input means for a digital television or the like is desired. Particularly, a method according to which a user who already has a user ID, such as the callee-user name, does not have to change the user ID is preferable.

In light of the foregoing, it is desirable to provide a terminal device, a signature generation server, a simple ID management system, a simple ID management method, and a program, which are new and improved, and which are capable of providing a mechanism that enables to easily specify, with an electronic device not provided with a full keyboard, a user who already has a user ID without making the user change the user ID.

According to an embodiment of the present invention, there is provided a terminal device which includes a simple ID registration unit that registers, in first auxiliary information which is managed in association with a user ID for specifying an individual user and which is made a search target at a time of searching for the user ID, a simple ID expressed by a combination of numbers or of a number and a specific symbol, and a signature registration unit that registers, in second auxiliary information which is managed in association with the first auxiliary information or the user ID and which is not made the search target, an electronic signature obtained, by using a signature key, from ID information including the user ID and the simple ID.

The terminal device may further include a uniqueness check unit that searches for the user ID with the simple ID registered by the simple ID registration unit as key information, and checks the number of user IDs that are detected. In a case multiple user IDs are detected as a result of search by the uniqueness check unit, the simple ID registration unit may newly register a different simple ID in the first auxiliary information. The signature registration unit may register, in the first or second auxiliary information, an electronic signature obtained, by using the signature key, from ID information including the user ID and the different simple ID.

The terminal device may further include a user information acquisition unit that searches for the user ID with the simple ID input by a user as key information, and acquires the user ID corresponding to the simple ID, the first auxiliary information and the second auxiliary information, a signature verification unit that verifies validity of a combination of the simple ID and the user ID by using the simple ID used for the search by the user information acquisition unit, the user ID acquired by the user information acquisition unit, the electronic signature included in the first or second auxiliary information acquired by the user information acquisition unit and a verification key corresponding to the signature key, and a user ID extraction unit that extracts, from at least one user ID acquired by the user information acquisition unit, a user ID whose validity is confirmed by the signature verification unit.

The simple ID may be determined based on a value obtained by inputting the user ID to a one-way function.

The ID information may include a system ID for specifying a system managing the user ID. The signature verification unit may verify validity of a combination of the simple ID, the user ID and the system ID by using the simple ID, the user ID, the electronic signature, the verification key and the system ID.

The terminal device may further include an ID information holding unit that holds, in association with each other, at least one user ID and at least one simple ID which corresponds to the at least one user ID and which is registered by the simple ID registration unit. When the simple ID is input by a user, the user information acquisition unit may search, with the at least one user ID and the at least one simple ID held in the ID information holding unit as targets, for a user ID corresponding to the simple ID that is input. In a case the user ID corresponding to the simple ID that is input is not detected among the at least one user ID and the at least one simple ID held in the ID information holding unit, the user information acquisition unit may search, with at least one user ID and at least one simple ID held by an external device as targets, for the user ID corresponding to the simple ID that is input.

According to another embodiment of the present invention, there is provided a signature generation server which includes an ID information acquisition unit that acquires, from a terminal device capable of registering a simple ID expressed by a combination of numbers or of a number and a specific symbol in first auxiliary information which is managed in association with a user ID for specifying an individual user and which is made a search target at a time of searching for the user ID, the user ID, the simple ID corresponding to the user ID and a generation request for an electronic signature based on the user ID and the simple ID, a signature generation unit that generates the electronic signature, by using a signature key, from ID information including the user ID and the simple ID acquired by the ID information acquisition unit, and a signature providing unit that provides the electronic signature generated by the signature generation unit to the terminal device. The electronic signature provided by the signature providing unit is managed in association with the first auxiliary information or the user ID and is registered in second auxiliary information which is not made the search target.

The signature generation server may further include a uniqueness check unit that searches for the user ID with the simple ID acquired by the ID information acquisition unit as key information, and checks the number of user IDs that are detected. In a case multiple user IDs are detected as a result of search by the uniqueness check unit, the simple ID to be registered in the first auxiliary information may be changed.

The signature generation server may further include a personal identification unit that accesses the terminal device by using the user ID acquired by the ID information acquisition unit and checks whether generation of the electronic signature is requested or not.

According to another embodiment of the present invention, there is provided a simple ID management system which includes a terminal device including a simple ID registration unit that registers, in first auxiliary information which is managed in association with a user ID for specifying an individual user and which is made a search target at a time of searching for the user ID, a simple ID expressed by a combination of numbers or of a number and a specific symbol, a signature generation request unit that provides, to a signature generation server, the user ID input by a user, the simple ID registered by the simple ID registration unit in association with the user ID and a generation request for an electronic signature based on the user ID and the simple ID, and a signature registration unit that registers, in second auxiliary information which is managed in association with the first auxiliary information or the user ID and which is not made the search target, the electronic signature provided by the signature generation server in response to a request from the signature generation request unit, and the signature generation server including an ID information acquisition unit that acquires, from the terminal device, the user ID, the simple ID corresponding to the user ID and the generation request for the electronic signature based on the user ID and the simple ID, a signature generation unit that generates the electronic signature, by using a signature key, from ID information including the user ID and the simple ID acquired by the ID information acquisition unit, and a signature providing unit that provides the electronic signature generated by the signature generation unit to the terminal device.

According to another embodiment of the present invention, there is provided a simple ID management method which includes the steps of registering, in first auxiliary information which is managed in association with a user ID for specifying an individual user and which is made a search target at a time of searching for the user ID, a simple ID expressed by a combination of numbers or of a number and a specific symbol, and registering, in second auxiliary information which is managed in association with the first auxiliary information or the user ID and which is not made the search target, an electronic signature obtained, by using a signature key, from ID information including the user ID and the simple ID.

According to another embodiment of the present invention, there is provided a simple ID management method which includes the steps of acquiring, from a terminal device capable of registering a simple ID expressed by a combination of numbers or of a number and a specific symbol in first auxiliary information which is managed in association with a user ID for specifying an individual user and which is made a search target at a time of searching for the user ID, the user ID, the simple ID corresponding to the user ID and a generation request for an electronic signature based on the user ID and the simple ID, generating the electronic signature, by using a signature key, from ID information including the user ID and the simple ID acquired in the step of acquiring, and providing the electronic signature generated in the step of generating to the terminal device. The electronic signature provided in the step of providing is managed in association with the first auxiliary information or the user ID and is registered in second auxiliary information which is not made the search target.

According to another embodiment of the present invention, there is provided a simple ID management method which includes the steps of registering by a terminal device, in first auxiliary information which is managed in association with a user ID for specifying an individual user and which is made a search target at a time of searching for the user ID, a simple ID expressed by a combination of numbers or of a number and a specific symbol, providing by the terminal device, to a signature generation server, the user ID input by a user, the simple ID registered in the step of registering in association with the user ID and a generation request for an electronic signature based on the user ID and the simple ID, acquiring by the signature generation server, from the terminal device, the user ID, the simple ID corresponding to the user ID and the generation request for the electronic signature based on the user ID and the simple ID, generating by the signature generation server the electronic signature from ID information including the user ID and the simple ID acquired in the step of acquiring, by using a signature key, providing by the signature generation server, to the terminal device, the electronic signature generated in the step of generating, and registering by the terminal device, in second auxiliary information which is managed in association with the first auxiliary information or the user ID and which is not made the search target, the electronic signature provided by the signature generation server in response to a request of the step of providing by the terminal device.

According to another embodiment of the present invention, there is provided a program for causing a computer to realise a simple ID registration function of registering, in first auxiliary information which is managed in association with a user ID for specifying an individual user and which is made a search target at a time of searching for the user ID, a simple ID expressed by a combination of numbers or of a number and a specific symbol, and a signature registration function of registering, in second auxiliary information which is managed in association with the first auxiliary information or the user ID and which is not made the search target, an electronic signature obtained, by using a signature key, from ID information including the user ID and the simple ID.

According to another embodiment of the present invention, there is provided a program for causing a computer to realise an ID information acquisition function of acquiring, from a terminal device capable of registering a simple ID expressed by a combination of numbers or of a number and a specific symbol in first auxiliary information which is managed in association with a user ID for specifying an individual user and which is made a search target at a time of searching for the user ID, the user ID, the simple ID corresponding to the user ID and a generation request for an electronic signature based on the user ID and the simple ID, a signature generation function of generating the electronic signature, by using a signature key, from ID information including the user ID and the simple ID acquired by the ID information acquisition function, and a signature providing function of providing to the terminal device the electronic signature that is generated by the signature generation function, so as to be managed in association with the first auxiliary information or the user ID and registered in second auxiliary information which is not made the search target.

According to another embodiment of the present invention, there is provided a recording medium in which the program is recorded, the recording medium being able to be read by a computer.

According to the embodiments of the present invention described above, there can be provided a mechanism that enables to easily specify, with an electronic device not provided with a full keyboard, a user who already has a user ID without making the user change the user ID.

### BRIEF DESCRIPTION OF THE DRAWINGS

FIG. 1 is an explanatory diagram showing an example of the system configuration of an IP telephony system (software method) according to an embodiment of the present invention;

FIG. 2 is an explanatory diagram showing an example of the functional configuration of a terminal device according to the first embodiment of the present invention;

FIG. 3 is an explanatory diagram showing an example of the functional configuration of a signature generation server according to the embodiment;

FIG. 4 is an explanatory diagram showing a registration sequence for a CE number according to the embodiment;

FIG. 5 is an explanatory diagram showing a calling sequence according to the embodiment;

FIG. 6 is an explanatory diagram showing a method of registration of a CE number and signature data according to the embodiment;

FIG. 7 is an explanatory diagram showing an example of the functional configuration of a terminal device according to the second embodiment of the present invention;

FIG. 8 is an explanatory diagram showing an example of the functional configuration of a signature generation server according to the embodiment;

FIG. 9 is an explanatory diagram showing a registration sequence for a CE number according to the embodiment; and

FIG. 10 is an explanatory diagram showing an example of the hardware configuration of an information processing apparatus capable of realising functions of the terminal devices and the signature generation servers according to the first and second embodiments of the present invention.

### DETAILED DESCRIPTION OF THE EMBODIMENT(S)

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

<Flow of Description>

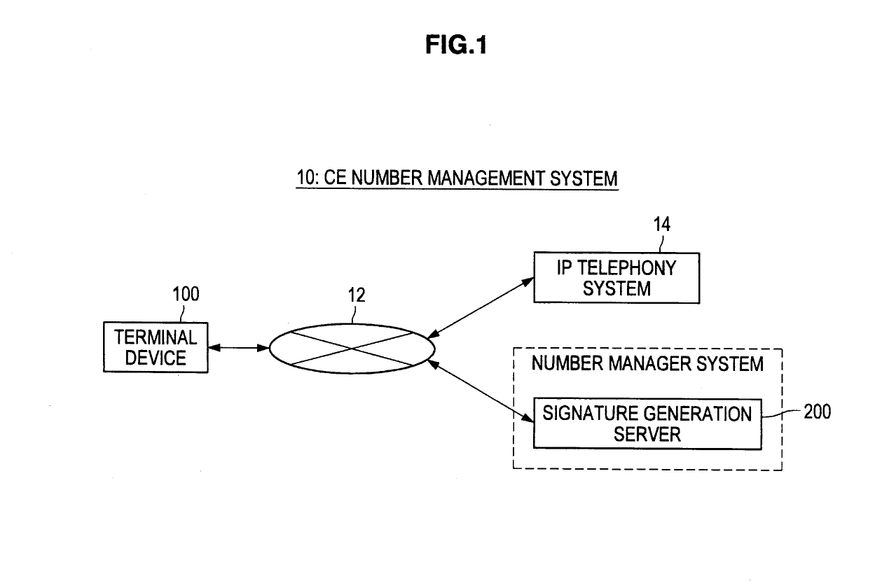

The flow of description relating to embodiments of the present invention described below will be briefly mentioned here. First, a system configuration of a CE number management system 10 according to the embodiment will be described with reference to FIG. 1.

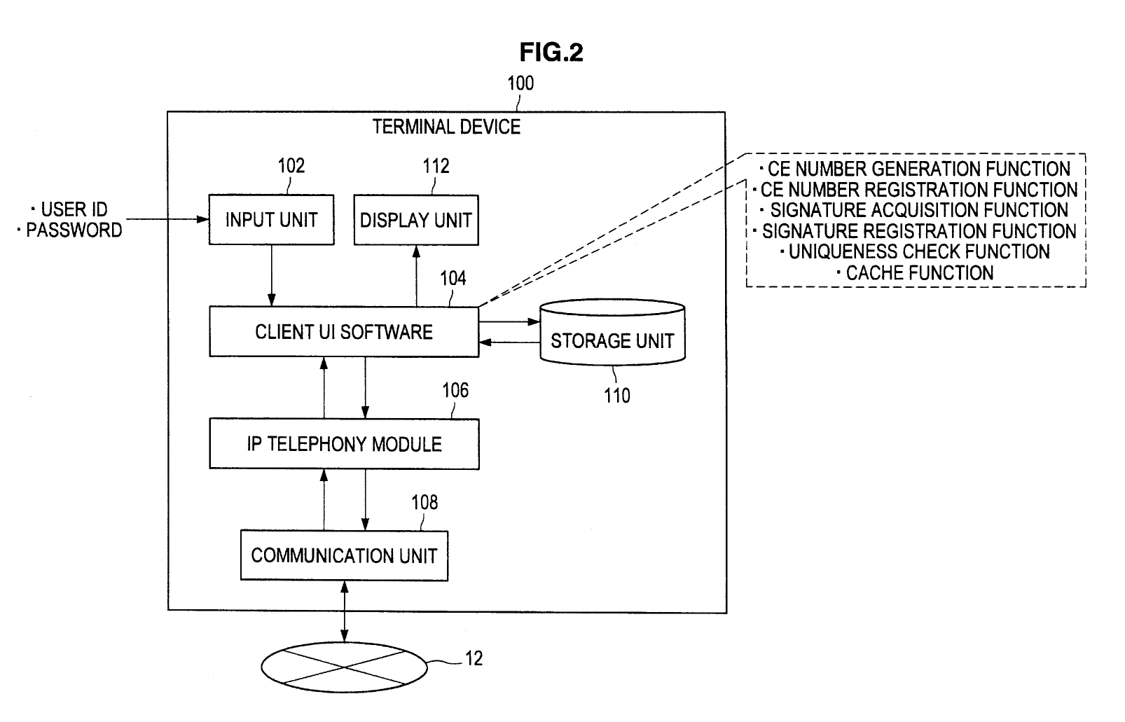

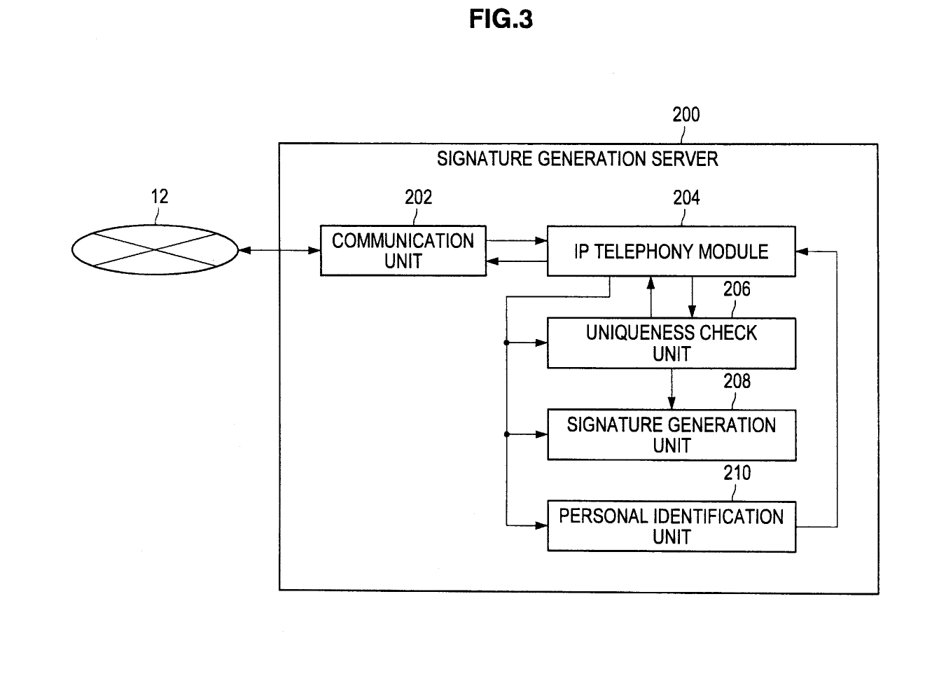

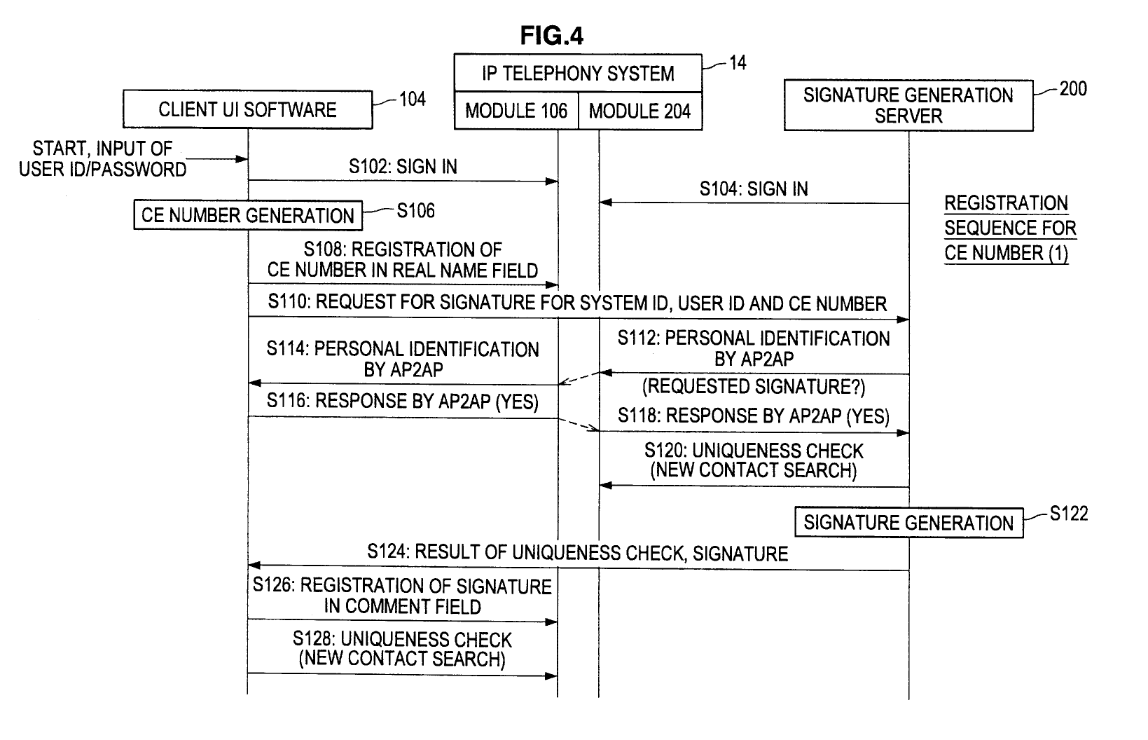

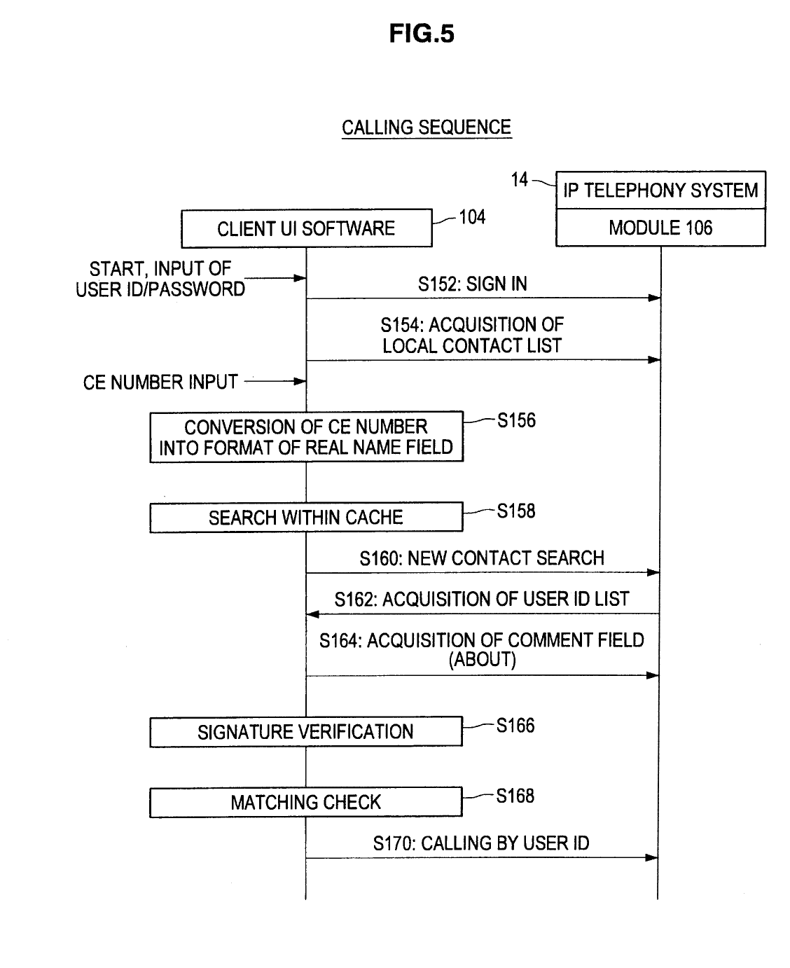

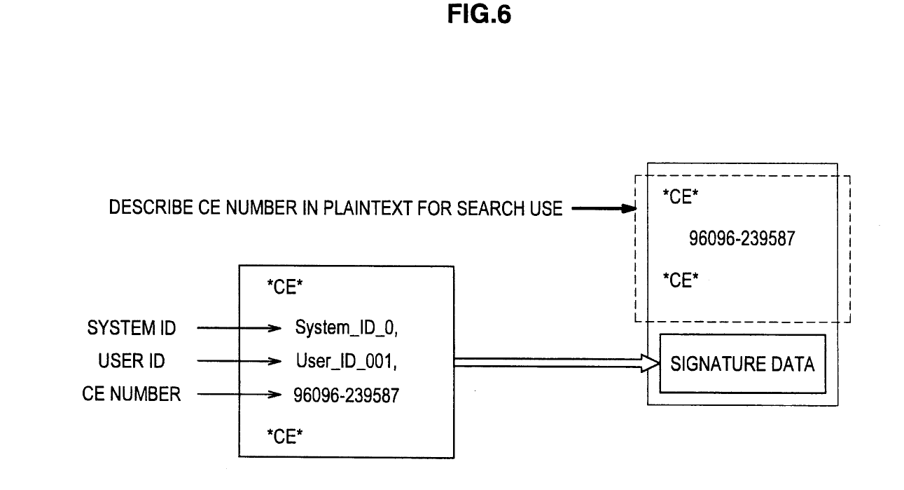

Next, a functional configuration of a terminal device 100 according to the first embodiment of the present invention will be described with reference to FIG. 2. Then, a functional configuration of a signature generation server 200 according to the embodiment will be described with reference to FIG. 3. Then, a registration sequence for a CE number according to the embodiment will be described with reference to FIG. 4. Then, a calling sequence according to the embodiment will be described with reference to FIG. 5. Furthermore, in this description, a method of registration of a CE number and signature data will be described with reference to FIG. 6.

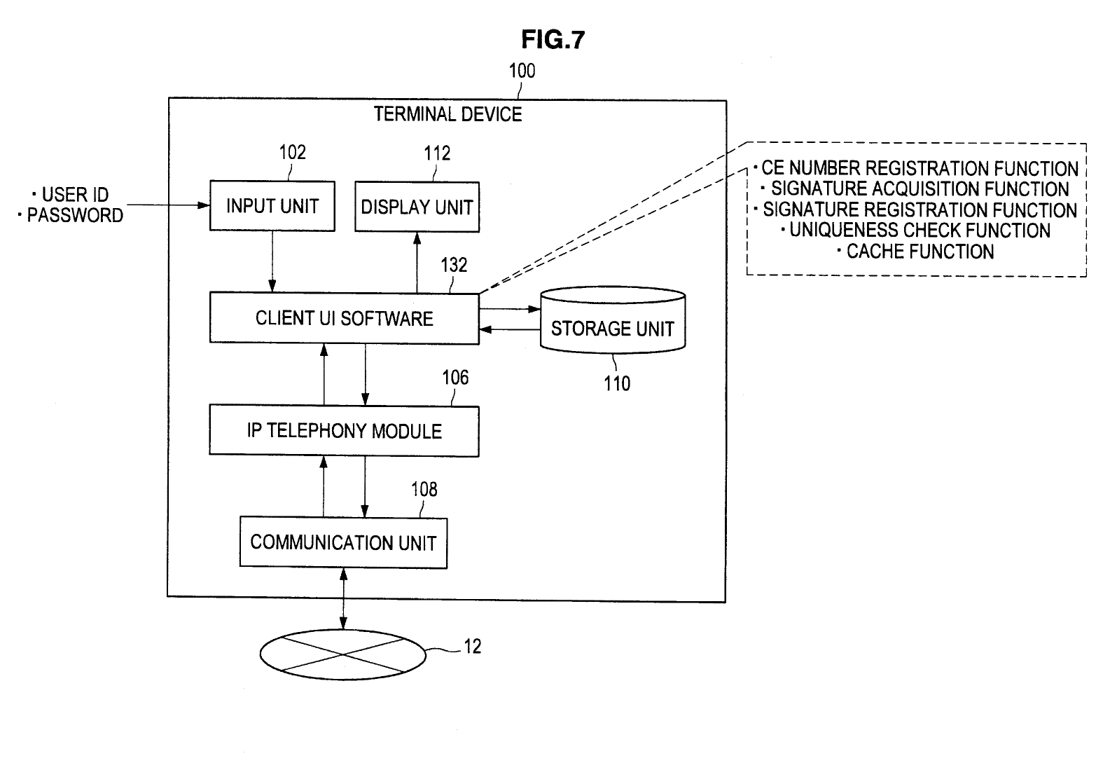

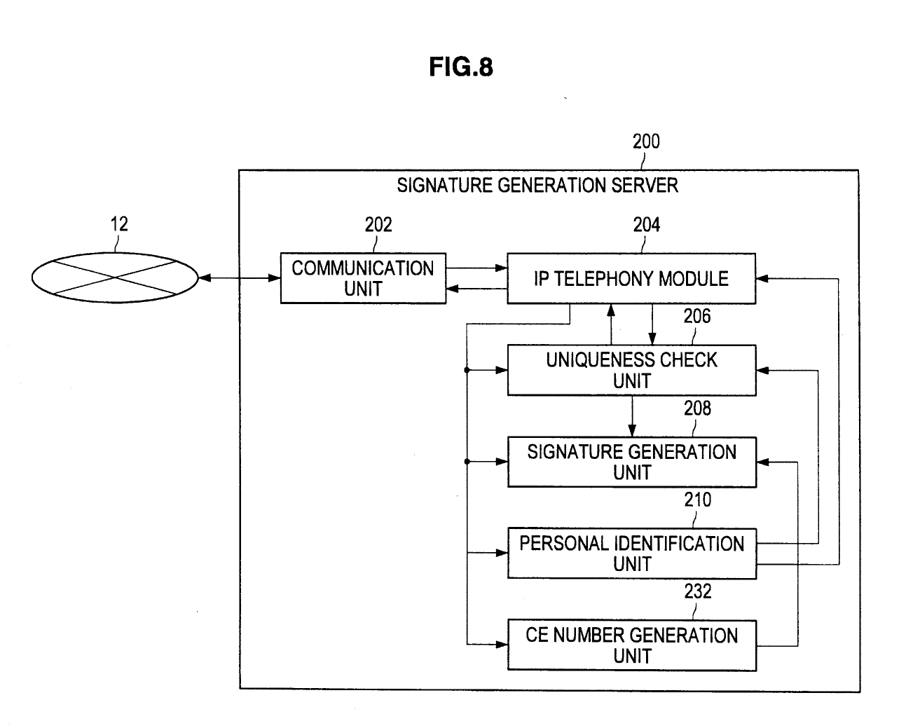

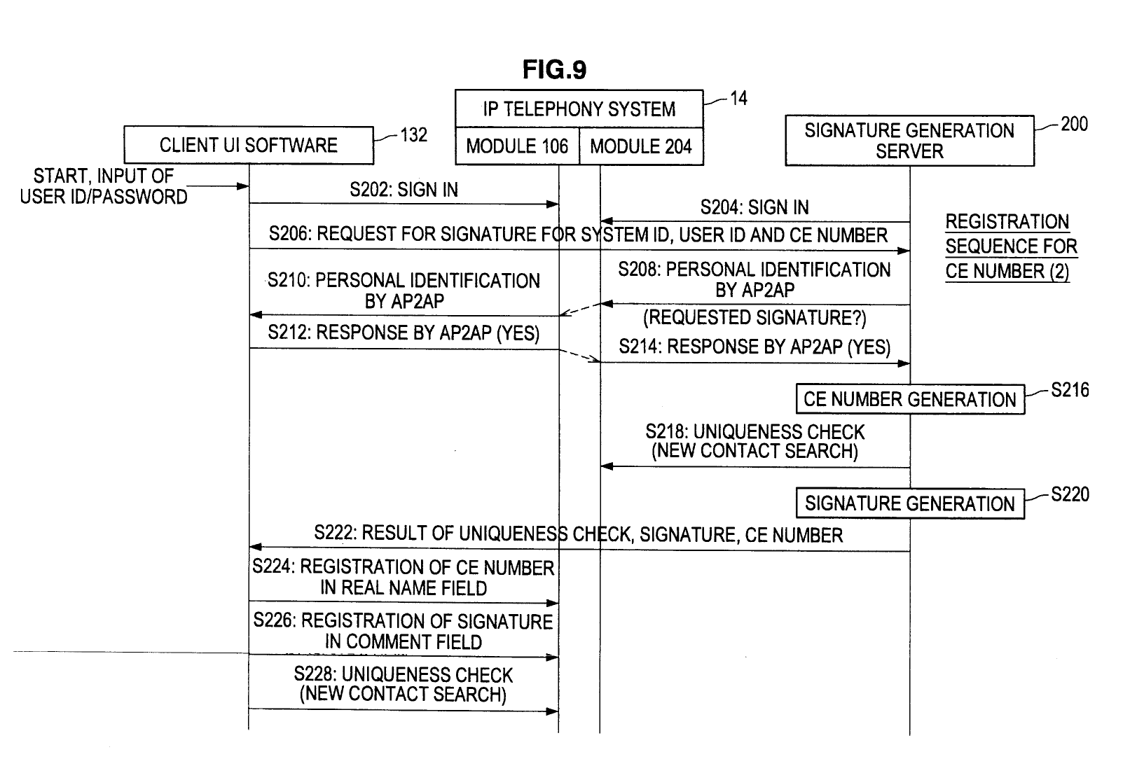

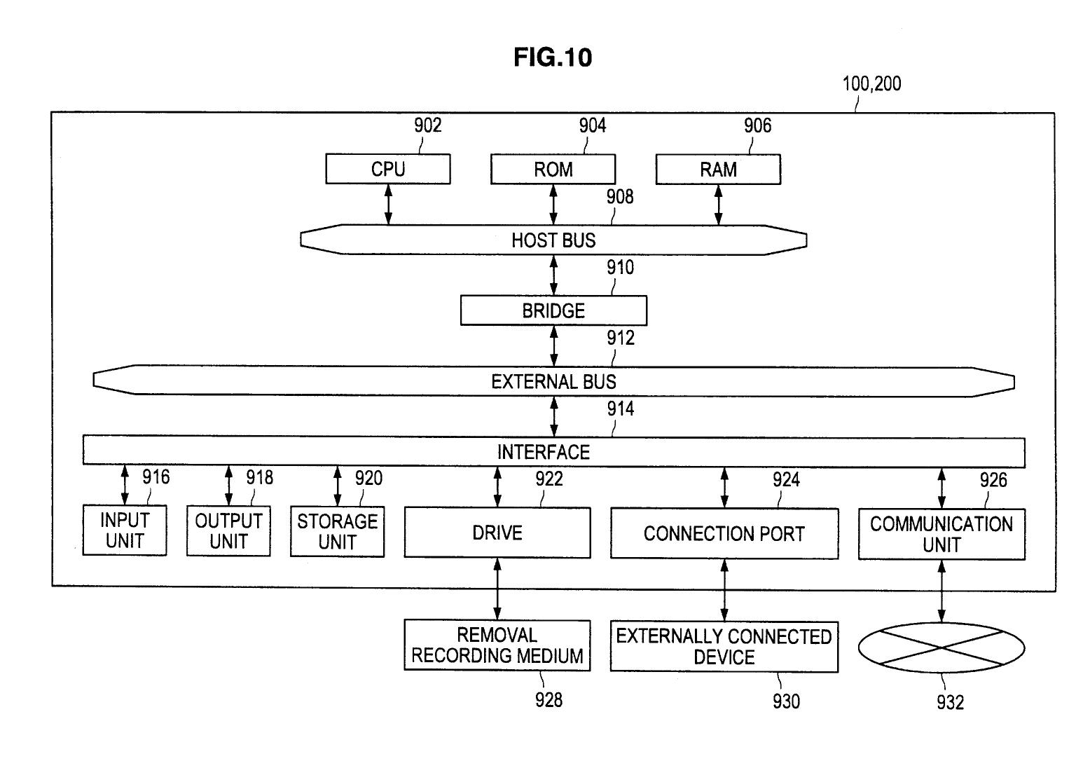

Next, a functional configuration of a terminal device 100 according to the second embodiment of the present invention will be described with reference to FIG. 7. Then, a functional configuration of a signature generation server 200 according to the embodiment will be described with reference to FIG. 8. Then, a registration sequence for a CE number according to the embodiment will be described with reference to FIG. 9. Then, an example of the hardware configuration of an information processing apparatus capable of realising functions of the terminal devices and the signature generation servers according to the first and second embodiments of the present invention will be described with reference to FIG. 10.

Lastly, the technical ideas of the first and second embodiments of the present invention will be summarized and operational effects obtained by the technical ideas will be briefly described.

(Description Items)

### 1: First Embodiment (Configuration of Generating CE Number at Terminal Device 100)

1-1: System Configuration

1-2: Functional Configuration of Terminal Device 100

1-3: Functional Configuration of Signature Generation Server 200

1-4: Registration Sequence

1-5: Calling Sequence

### 2: Second Embodiment (Configuration of Generating CE Number at Signature Generation Server 200)

2-1: Functional Configuration of Terminal Device 100

2-2: Functional Configuration of Signature Generation Server 200

2-3: Registration Sequence

### 3: Hardware Configuration Example

### 4: Summary

### 5: Supplement

### 1: First Embodiment (Configuration of Generating CE Number at Terminal Device 100)

In the following, an explanation will be given on the first embodiment of the present invention. The present embodiment relates to a technology for enabling a user to easily specify a callee by using an input device, such as a remote control, at the time of using an IP telephony service of the software method. Additionally, an IP telephony service is taken as an example here, but the application scope of the technology according to the present embodiment is not limited to such. For example, application to a service according to which a callee is specified by specifying a user ID and data sharing, chat or the like is performed with the specified callee is also possible.

As the IP telephony service of the software method, a P2P (peer-to-peer) telephony service, such as Skype (registered trademark; hereinafter, SKP) is known, for example. To use such existing P2P telephony service, a user is asked to input a user ID expressed by a combination of alphabets or symbols. However, an input device such as a remote control used for operation of a digital television or the like is designed to have mainly numbers input thereto, and it is not easy to input alphabets or the like by using such input device. For this reason, the inventor of the present invention has devised a technology that enables to easily specify a callee even when the input device as mentioned above is used. In the following, the technology will be described in detail while referring to a concrete example.

<1-1: System Configuration>

First, a configuration of a CE number management system 10 according to the present embodiment will be described with reference to FIG. 1. FIG. 1 is an explanatory diagram showing an example of the system configuration of the CE number management system 10 according to the present embodiment. Additionally, the CE number management system 10 is an example of application of the technology of the present embodiment to a system that provides an IP telephony service.

As shown in FIG. 1, the CE number management system 10 is configured from an IP telephony system 14, a terminal device 100, and a signature generation server 200 (a number manager system). Furthermore, the IP telephony system 14, the terminal device 100 and the signature generation server 200 are connected to each other via a network 12. Additionally, although not shown in FIG. 1, multiple user terminals are assumed to be connected to the IP telephony system 14 via the network 12.

The IP telephony system 14 is a system for providing an IP telephony service. For example, the IP telephony system 14 manages user IDs for specifying individual users using the IP telephony service. Also, the IP telephony system 14 manages auxiliary information for management of a user profile of each user. For example, in the case of SKP, the IP telephony system 14 manages, as the auxiliary information, “real name of user (FULL NAME attribute of display name, USER object or PROFILE object),” “comment (ABOUT attribute of USER object or PROFILE object)” and the like. These pieces of information are registered by a user.

Furthermore, the IP telephony system 14 has a function of searching for a user ID (hereinafter, a new contact search) with the above-described auxiliary information as a search target. Note that, in the case of SKP, the auxiliary information to be the target of the new contact search is only the portion corresponding to the “real name of user” (hereinafter, the first auxiliary information). The portion corresponding to the “comment” (hereinafter, the second auxiliary information), on the other hand, is not included in the search target, but is configured to enable registration of a relatively long character string (for example, 256 characters (=2048 bits) or more). This new contact search is a function that can be used by any user as necessary. When using this function, all the user IDs including a specified character string and the first and second auxiliary information corresponding to each user ID can be acquired, for example.

Of course, the IP telephony system 14 has a function of providing an IP telephony service. For example, in a case a user with a user ID=SK001 requests connection with a user ID=SK002 specified as the callee, the IP telephony system 14 notifies a user terminal of the user ID=SK001 of address information (for example, an IP address) of a user terminal of the user ID=SK002. After the notification of the address information, a communication path by P2P is established between these user terminals, and communication via the network 12 is enabled. Additionally, in the case of SKP, the IP telephony system 14 is configured from a super node, a user authentication server, a relay node or other P2P node.

Moreover, in the present embodiment, a mechanism is provided that spares a user manual input of a user ID, such as “SK002,” in which alphabets are mixed. With the provision of such mechanism, a callee can be easily specified even with a user terminal not provided with a full keyboard. As a result, it becomes possible to use various consumer electronics devices (hereinafter, CE device) as a user terminal capable of realising an IP telephone function of the software method.

The mechanism as described is realised by the new contact search function of the IP telephony system 14 and functions of a terminal device 100 and a signature generation server 200 described later. In the following, a functional configuration of the terminal device 100 and a functional configuration of the signature generation server 200 will be described.

<1-2: Functional Configuration of Terminal Device 100>

First, a functional configuration of a terminal device 100 according to the present embodiment will be described with reference to FIG. 2. FIG. 2 is an explanatory diagram showing an example of the functional configuration of the terminal device 100 according to the present embodiment.

As shown in FIG. 2, the terminal device 100 is mainly configured from an input unit 102, client UI software 104, an IP telephony module 106, a communication unit 108, a storage unit 110, and a display unit 112. Additionally, the IP telephony module 106 is interface software used at the time of using a function of the IP telephony system 14. Furthermore, the IP telephony module 106 is provided by a manger of the IP telephony system 14, for example.

(Function Performed at the Time of CE Number Registration)

As has been described, the CE number management system 10 of the present embodiment is provided with a mechanism that spares a user manual input of a user ID of a callee at the time of initiating a call. Specifically, there is provided a mechanism that allows input of a simple ID (hereinafter, CE number) expressed by a combination of numbers and specific symbols (for example, “#” and “*”) that are easy to input with a remote control or the like, instead of input of a user ID including a character string that is difficult to input with the remote control or the like.

The above-described mechanism is realised by registering the CE number in first auxiliary information. This first auxiliary information is included in search targets of the new contact search of the IP telephony system 14. Therefore, by having the CE number registered in the first auxiliary information, a user ID can be detected by the new contact search with the CE number as key information. That is, if the CE number of each user is registered in the first auxiliary information corresponding to each user ID, a desired user ID can be detected by the input of the CE number and the new contact search with the CE number that is input as key information.

Moreover, in a case of performing the new contact search with a certain CE number as key information, it is conceivable that multiple user IDs are detected. Accordingly, the inventor of the present invention has devised a method of detecting, from multiple user IDs detected by the new contact search, a correct user ID by using a signature verification technology. This method is for registering, in the first or second auxiliary information, an electronic signature generated, by using a signature key, from ID information including a user ID and a CE number. Additionally, the electronic signature is obtained by generating the ID information by linking a user ID and a CE number, and by encrypting the same by using the signature key, for example. Moreover, a verification key forming a pair with the signature key is assumed to be made known to a user in some way.

As described above, when an electronic signature is registered in the first or second auxiliary information, even if multiple user IDs are obtained by the new contact search using the CE number, a correct user ID can be obtained by verifying the CE number registered in the first or second auxiliary information of each user ID. That is, a user ID for which signature verification has succeeded is the correct user ID. By using such method, a user ID corresponding to a CE number can be detected by using the new contact search. Furthermore, since an electronic signature is used, high resistance to alteration of the CE number or the like can be obtained.

Furthermore, operation of a database server or the like for management of the CE number is not necessary, and thus operating cost can be reduced. Furthermore, to reduce management cost of the CE number, a method of generating the CE number from a user ID by using a reversible transform algorithm based on a specific mathematical rule can be conceived. However, when using this method, the CE number will be an extremely large number (more than 50 digits in some cases), and manual input by a user will be difficult. The above-described mechanism of the present embodiment is for solving these issues. Furthermore, the above-described mechanism of the present embodiment also has an advantage that it can be realised without changing the user ID of an existing user.

Now, to realise the above-described mechanism of the present embodiment, first, a process of registering the CE number in the first auxiliary information and the electronic signature in the first or second auxiliary information becomes necessary. Such registration process is realised by a function of the terminal device 100. Accordingly, the function of the terminal device 100 relating to the registration process of the CE number and the electronic number will be described in the following.

As described above, the new contact search function of the IP telephony system 14 and a signature generation function of the signature generation server 200 are used for registration of the CE number. Accordingly, at the time of registering a CE number, a user has to sign in to the IP telephony system 14. First, the user inputs a user ID and a password via the input unit 102. The user ID and the password input via the input unit 102 are input to the IP telephony module 106 via the client UI software 104. When the user ID and the password are input, the IP telephony module 106 accesses the IP telephony system 14, and signs in to the IP telephony system 14 by using the user ID and the password that have been input.

Furthermore, the client UI software 104 generates a CE number with a specific number of digits (for example, ten digits or less) expressed by a combination of numbers or of numbers and specific symbols. Here, the CE number may be generated based on a value obtained by inputting the user ID to a one-way function. For example, the client UI software 104 extracts a number sequence with a specific number of digits from a hash value obtained by inputting the user ID to a hash function, and sets the number sequence as the CE number. Then, the client UI software 104 writes the CE number in a column of the first auxiliary information corresponding to the user ID of itself by using the IP telephony module 106. The CE number is registered in the first auxiliary information in this manner.

Next, the client UI software 104 performs the new contact search with the CE number registered in the first auxiliary information as key information, by using the IP telephony module 106. If there are overlapping CE numbers, multiple user IDs will be detected by this new contact search. In the case multiple user IDs are detected, the client UI software 104 newly generates a CE number, and re-registers the new CE number in the first auxiliary information. Then, the client UI software 104 performs the new contact search with the new CE number as the key information, and checks whether there are overlapping CE numbers.

In the following explanation, the process of checking whether there are overlapping CE numbers by using the new contact search in the manner described above will be referred to as “uniqueness check (process).” Additionally, the uniqueness check may be performed immediately after the setting of the CE number as described above, or may be performed at other timings. Also, processes of generation, registration and uniqueness check with respect to the CE number are preferably repeatedly performed until there are no overlapping CE numbers. When the uniqueness of the CE number is confirmed in this manner, the client UI software 104 transmits a generation request for generation of an electronic signature to the signature generation server 200 via the communication unit 108. At this time, the client UI software 104 transmits the user ID and the CE number to the signature generation server 200.

The electronic signature generated by the signature generation server 200 in response to the generation request is received by the communication unit 108, and is input to the client UI software 104. When the electronic signature is input, the client UI software 104 writes the electronic signature in a column of the first or second auxiliary information by using the IP telephony module 106. An electronic signature is registered in the first or second auxiliary information in this manner. Additionally, whether the electronic signature is to be registered in the first auxiliary information or in the second auxiliary information is preferably set as appropriate according to the amount of data that can be written in each auxiliary information, the specification of the IP telephony system 14 or the like.

The CE number registered in the manner described above is recorded, by the client UI software 104, in the storage unit 110 in association with the user ID. Also, a user interface provided by the client UI software 104 and a user interface provided by the IP telephony module 106 are displayed on the display unit 112. Furthermore, according to a CE device that uses a software keyboard as an input device, the software keyboard is displayed on the display unit 112, and a function of the input unit 102 is provided to a user.

Heretofore, a functional configuration of the terminal device 100 used for registration of the CE number or the like has been described.

(Function Performed at the Time of Communication Initiation)

Next, a functional configuration of a terminal device 100 operating at the time of communication initiation will described. Additionally, the terminal device 100 to be used for communication does not have to have the same functional configuration as the terminal device 100 used for registration of the CE number. For example, the input unit 102 of the terminal device 100 used at the time of registration of the CE number is preferably a full keyboard or the like with which input of alphabets and the like is easy, from the standpoint of convenience of a user. On the other hand, the input unit 102 of the terminal device 100 used at the time of communication may be an input device such as a remote control with which input of alphabets and the like is not easy.

Now, in the case of initiating communication, a user inputs a CE number corresponding to his/her user ID by using the input unit 102. The CE number input by the user is input to the client UI software 104. When the CE number is input, the client UI software 104 reads a user ID recorded in the storage unit 110, and signs in, by using the user ID that is read, to the IP telephony system 14 by the IF telephony module 106.

Next, the user inputs the CE number of a callee by using the input unit 102. The CE number of the callee input by the user is input to the client UI software 104. When the CE number of the callee is input, the client UI software 104 performs, by using the IP telephony module 106, the new contact search with the CE number of the callee as key information. However, in a case a list of callee-users with whom communication was performed previously (a list including a user ID of a callee, the first and second auxiliary information; hereinafter, contact list) can be obtained from the IF telephony system 14, the client UI software 104 searches for a user ID corresponding to the CE number of the callee that has been input from the contact list before performing the new contact search.

Additionally, the contact list is held by the IP telephony system 14, for example. In the case of SKP, when the sign-in is complete, a user can acquire his/her own contact list, the contact list being managed for each user ID. With the contact list for a user himself/herself being managed on per user ID basis, even when signing in by using a different user terminal, a user can use his/her own contact list.

Now, in the case the new contact search is performed, the client UI software 104 acquires the user ID detected by the new contact search and the first and second auxiliary information corresponding to the user ID. At this time, multiple user IDs are sometimes detected. Then, the client UI software 104 extracts an electronic signature from the first or second auxiliary information of each user ID that has been acquired. Then, the client UI software 104 performs signature verification by using the CE number of the callee used as the key information, the acquired user ID and the extracted electronic signature. Additionally, in the case multiple user IDs are detected, the client UI software 104 performs signature verification for each user ID.

Then, the client UI software 104 selects a user ID whose validity regarding the combination of the CE number and the user ID is confirmed by the signature verification described above. Additionally, in a case no user ID is detected by the new contact search or in a case signature verification has failed for all the user IDs, the client UI software 104 determines that the CE number of the callee input by the user is invalid. In this case, the client UI software 104 displays on the display unit 112 that connection to the callee by the CE number of the callee has failed.

In a case a user ID is selected based on the signature verification, the client UI software 104 specifies the selected user ID as the callee, and requests the IP telephony system 14 by the IP telephony module 106 of connection to a user terminal of the callee. When this connection request is received, the IP telephony system 14 notifies the terminal device 100 of address information of a user terminal corresponding to the user ID of the specified callee. This address information is input to the IP telephony module 106. Then, connection is made to the user terminal of the callee by the IP telephony module 106, and an IP telephony service is started.

Additionally, in the case the client UI software 104 succeeded in selecting a user ID based on the above-described signature verification, the client UI software 104 records the CE number and the user ID in the storage unit 110 in association with each other. Then, in a case a callee is specified by the user by the same CE number, the client UI software 104 searches for the CE number recorded in the storage unit 110 before performing the new contact search, and detects the user ID corresponding to the CE number. According to such configuration, a desired user ID can be acquired without performing the new contact search. As a result, time until communication can be reduced, and also, load on the IP telephony system 14 can be reduced.

Heretofore, a functional configuration of the terminal device 100 has been described. Additionally, the function configuration of the terminal device 100 can be modified as appropriate as long as it is within the technical scopes of the method of registration of the CE number or the like and the method of initiating communication by the CE number according to the present embodiment. For example, modification of adding the function of the client UI software 104 to the IP telephony module 106 is possible. Also, modification of using an electronic signature that takes into consideration a system ID for specifying the type of the IP telephony system 14, besides the user ID and the CE number, is also possible. In this case, since the type of the IP telephony system 14 is specified by the signature verification, a correct combination of the user ID and the CE number can be detected from search results by multiple IP telephony systems 14.

<1-3: Functional Configuration of Signature Generation Server 200>

Next, a functional configuration of a signature generation server 200 according to the present embodiment will be described with reference to FIG. 3. FIG. 3 is an explanatory diagram showing an example of the functional configuration of the signature generation server 200 according to the present embodiment. Additionally, this signature generation server 200 functions as a part of a number manager system managed by a number manager or the like providing a system for searching for a user ID by the use of a CE number (see FIG. 1).

As shown in FIG. 3, the signature generation server 200 mainly includes a communication unit 202, an IP telephony module 204, a uniqueness check unit 206, a signature generation unit 208, and a personal identification unit 210. The signature generation server 200 may include multiple IP telephony modules 204 corresponding to multiple IP telephony systems 14. Also, the signature generation server 200 is assumed to hold a user ID and a password for signing in to the IP telephony system 14. In the following explanation, the signature generation server 200 is assumed as signed in to the IP telephony system 14 by using the user ID and the password.

As has been described in the explanation relating to the functional configuration of the terminal device 100, the signature generation server 200 is used at the time of registration of a CE number. As described above, at the time of registering a CE number, a user ID and the CE number are provided, in addition to a signature generation request, to the signature generation server 200 from the terminal device 100. Additionally, a system ID is already known to the signature generation server 200. It is assumed here that a user ID and a CE number are provided. The user ID acquired from the terminal device 100 is input to the personal identification unit 210 via the communication unit 202. Also, the CE number is input to the uniqueness check unit 206. Furthermore, the user ID and the CE number are input to the signature generation unit 208.

When the signature generation request is received, first, the personal identification unit 210 requests the IP telephony system 14 by the IP telephony module 204 of connection to the terminal device 100, by using the user ID that has been input. When address information of the terminal device 100 is obtained by the IP telephony system 14, the personal identification unit 210 connects to the terminal device 100 by using the IP telephony module 204, and issues an inquiry of whether the signature generation request has been issued or not. This inquiry is notified to the client UI software 104 of the terminal device 100, and whether the signature generation request has been issued or not is determined. Then, a determination result is notified to the personal identification unit 210 via the IP telephony modules 106 and 204. Here, it is assumed that a determination result of the signature generation request “requested” is notified.

When the determination result is notified and it is confirmed that a user corresponding to the acquired user ID is the user who has issued the signature generation request, information indicating the success of personal identification is notified from the personal identification unit 210 to the uniqueness check unit 206. When this notification is received, the uniqueness check unit 206 performs, by using the IP telephony module 204, the new contact search with the input CE number as key information (uniqueness check). In a case multiple user IDs are detected by this new contact search, the detection result is notified to the terminal device 100. Depending on the case, a notification is sent to the terminal device 100 to change the CE number.

When the uniqueness of the CE number is confirmed by the new contact search, a notification that the uniqueness has been confirmed is sent from the uniqueness check unit 206 to the signature generation unit 208. When this notification is received, the signature generation unit 208 generates an electronic signature by using the user ID and the CE number that have been input. For example, the signature generation unit 208 generates ID information by linking the user ID and the CE number, and generates an electronic signature by encrypting the ID information by a signature key that is secretly managed. Additionally, the signature key forms a pair with a verification key that is made known to the terminal device 100. The electronic signature obtained in this manner is provided to the terminal device 100.

Moreover, in a case a system ID is provided, ID information including the user ID, the CE number and the system ID is encrypted, and the ciphertext is used as the electronic signature. Also, communication performed between the terminal device 100 and the signature generation server 200 is performed securely by using a technology such as SSL/TSL or the like.

Heretofore, a functional configuration of the signature generation server 200 has been described. This signature generation server 200 is used at the time of assigning a CE number. Accordingly, compared to a server or the like of the IP telephony system 14 that is accessed at every communication initiation, the load caused by being accessed is significantly less. For this reason, a processing capacity expected of the signature generation server 200 is not high.

Furthermore, as can be surmised from the above explanation, the signature generation server 200 corresponds to a certificate authority (CA) for issuing a certificate having the user ID and the CE number as an identity. Accordingly, a platform used for the operation of an existing CA (for example, an openss1 platform) can be applied for the operation of the signature generation server 200. Furthermore, the verification key may be stored in the client UI software 104 in advance, or may be acquired from the signature generation server 200 by using a secure communication channel.

<1-4: Registration Sequence>

Next, a processing sequence performed at the time of registration of a CE number (and an electronic signature) at the CE number management system 10 of the present embodiment will be described with reference to FIG. 4. FIG. 4 is an explanatory diagram showing a processing sequence performed at the time of registration of a CE number (and an electronic signature) at the CE number management system 10 of the present embodiment.

As shown in FIG. 4, first, the client UI software 104 is started by a user, and a user ID and a password are input. When the user ID and the password are input, the client UI software 104 signs in to the IP telephony system 14 via the IP telephony module 106 (S102). On the other hand, the signature generation server 200 also signs in to the IP telephony system 14 via the IP telephony module 204 (S104). When the sign-ins are complete, the client UI software 104 generates a CE number (S106).

Next, the client UI software 104 registers the CE number in the first auxiliary information (for example, a real name field) by using the IP telephony module 106 (S108). Then, the client UI software 104 transmits the user ID and the CE number (and a system ID) to the signature generation server 200, and requests for the generation of an electronic signature (S110). When this request is received, the signature generation server 200 performs, by using the received user ID, personal identification via the IP telephony modules 106 and 204 (S112, S114). At this time, an inquiry of whether the request for the signature generation is issued or not is notified from the signature generation server 200 to the terminal device 100 (client UI software 104) via the IP telephony system 14 (by AP2AP).

When this inquiry is received, the client UI software 104 sends back a response to the inquiry to the signature generation server 200 via the IP telephony system 14 (S116, S118). Here, since the client UI software 104 has requested for the signature generation, a response YES is notified to the signature generation server 200. When this response is received, the signature generation server 200 performs, by using the IP telephony module 204, the new contact search with the CE number acquired in advance as key information (S120). The uniqueness of the CE number is checked by this new contact search.

When the uniqueness of the CE number is confirmed by the process of step S120, the signature generation server 200 generates an electronic signature by using the user ID and the CE number (and the system ID) that have been acquired in advance (S122). Then, the signature generation server 200 transmits to the client UI software 104 the generated electronic signature together with the result of the uniqueness check (S124). Additionally, in a case the uniqueness of the CE number is not confirmed by the process of step S120, the signature generation server 200 may notify to the client UI software 104 that the confirmation of the uniqueness has failed, without generating an electronic signature. Here, it is assumed that the uniqueness is confirmed.

When the electronic signature is received, the client UI software 104 registers the received electronic signature in the first or second auxiliary information (S126). For example, the client UI software 104 writes the electronic signature in a comment field corresponding to the part of the second auxiliary information. Then, the client UI software 104 performs the new contact search with the CE number as key information, and checks the uniqueness of the CE number (S128). In a case the uniqueness of the CE number is not confirmed, the client UI software 104 newly generates a CE number, and performs again the process of step S108 and subsequent processes. Furthermore, also in a case where a check result denying the uniqueness is obtained from the signature generation server 200 in the step S124, the client UI software 104 performs again the process of step S108 and subsequent processes by using a new CE number.

Heretofore, the processing sequence of the CE number management system 10 relating to the registration of the CE number or the like has been described. By the processing sequence described above, the CE number and the electronic signature are registered in the auxiliary information of a user ID, as shown in FIG. 6. Additionally, the CE number to be registered in the first auxiliary information will be used for the new contact search, and thus, it is written in plaintext. Furthermore, as shown in FIG. 6, the CE number is written, being converted as appropriate to the description format of the first auxiliary information.

### <1-5: Calling Sequence>

Next, a processing sequence performed at the time of communication initiation at the CE number management system 10 of the present embodiment will be described with reference to FIG. 5. FIG. 5 is an explanatory diagram showing a processing sequence performed at the time of communication initiation at the CE number management system 10 of the present embodiment.

As shown in FIG. 5, first, the client UI software 104 is started by a user, and a user ID (or a CE number) and a password are input. When the user ID (or the CE number) and the password are input by the user, the client UI software 104 signs in to the IP telephony system 14 by using the IP telephony module 106 (S152). When the sign-in is complete, the client UI software 104 acquires a contact list (a local contact list in the case of SKP) from the IP telephony system 14 (S154). Additionally, in a case the user ID used for the sign-in is recorded in the storage unit 110 in association with the CE number, the user can perform the procedure of signing in by using the CE number.

When the CE number of a callee is input by the user, the client UI software 104 converts the input CE number into a format matching the description format of the first auxiliary information (for example, the real name field) (S156). Next, the client UI software 104 searches for a user ID corresponding to the input CE number from the list of user IDs recorded in the storage unit 110 (cache) (S158). In a case a corresponding user ID does not exist in the storage unit 110, the client UI software 104 performs the new contact search with the input CE number as key information by using the IP telephony module 106 (S160).

Then, the client UI software 104 acquires, as a result of the new contact search, a list of user IDs (S162). Then, the client UI software 104 acquires the first or second auxiliary information of each user ID included in the acquired list of user IDs (S164). Moreover, in step S164, auxiliary information in which an electronic signature is registered is acquired. For example, in a case of use where the electronic signature is registered in the comment field, which is the second auxiliary information, the contents of the comment field is acquired in step S164. Then, the client UI software 104 extracts the electronic signature from the first or second auxiliary information that has been acquired.

Next, the client UI software 104 performs signature verification by using a verification key, the user ID and the CE number (and a system ID) (S166). Additionally, the verification key may be stored in the client UI software 104 in advance, or may be acquired from the signature generation server 200 by using a secure communication channel. Here, the client UI software 104 extracts a user ID for which the signature verification has succeeded. Then, the client UI software 104 checks whether the CE number included in the first auxiliary information of the extracted user ID and the CE number used for the new contact search match or not (S168; a matching check). Furthermore, in the case of a configuration where a system ID is used, matching of the system may also be checked as appropriate.

When matching is confirmed in step S168, the client UI software 104 inputs to the IP telephony module 196 the user ID that is extracted after step S166, and provides the user with an IP telephony service that uses the IP telephony module 106 (S170). When a user ID is extracted in this manner, the IP telephony service itself that uses the IP telephony module 106 is realised by an existing IP telephony system 14. That is, the mechanism of the present embodiment does not call for a change in the system configuration of the IP telephony system 14. Accordingly, the technology of the present embodiment can be applied to various IP telephony systems 14.

Heretofore, a processing sequence performed at the time of communication initiation at the CE number management system 10 has been described.

In the above-described explanation, a method of using a cache or a contact list prior to the new contact search is described. The explanation on the method of using the contact list or the cache will be supplemented here. In the case of SKP, the contact list is managed for each user ID, and is acquired from the IP telephony system 14. If the contact list is acquirable as in the case of SKP, a method of using the contact list in priority to the cache can be conceived (preferential use of contact list). Also, a method of updating the contents of the cache based on the information of the acquired contact list, and mainly using the information of the cache can be conceived (supplemental use of contact list). The technology of the present embodiment can be applied to either method.

As described above, when using the method of managing the CE number according to the first embodiment of the present invention, a callee-user can be specified, at the time of a user initiating communication, by using a CE number that can be easily input with a remote control or the like. Also, since a method of guaranteeing the correspondence relationship between a CE number and a user ID by an electronic signature is used, resistance to alteration of a registered CE number or the like is high. Furthermore, the method of the present embodiment is for enabling the use of a CE number within the framework of an existing IP telephony system 14 without modifying an existing user ID, and thus an already registered user ID can be efficiently used. Furthermore, since operation of a database server or the like managing the correspondence relationship of a user ID and a CE number is not necessary, management cost can be kept low.

<2: Second Embodiment (Configuration of Generating CE Number at Signature Generation Server 200)>

Next, the second embodiment of the present invention will be described.

In the first embodiment described above, a method of generating a CE number at the terminal device 100 was adopted. However, the process of generating a CE number may be also performed at the signature generation server 200. Accordingly, in the following, a configuration of performing the process of generating a CE number at the signature generation server 200 will be described.

<2-1: Functional Configuration of Terminal Device 100>

First, a functional configuration of a terminal device 100 according to the present embodiment will be described with reference to FIG, 7. FIG. 7 is an explanatory diagram showing an example of the functional configuration of the terminal device 100 according to the present embodiment. Note that detailed description of structural elements that have substantially the same function as those of the terminal device 100 according to the first embodiment described above will be omitted.

As shown in FIG. 7, the terminal device 100 is mainly configured from an input unit 102, client UI software 132, an IP telephony module 106, a communication unit 108, a storage unit 110, and a display unit 112. The main difference to the terminal device 100 according to the first embodiment described above lies in a function of the client UI software 132. Accordingly, in the following, a function of the client UI software 132 will be mainly described.

As described above, the CE number management system 10 of the present embodiment is configured such that a process of generating a CE number is performed by the signature generation server 200. Accordingly, a function for generating a CE number is omitted in the client UI software 132. At the time of registration of a CE number or the like, first, after signing in to the IP telephony system 14, the client UI software 132 transmits a user ID (and a system ID) to the signature generation server 200 and requests for generation of an electronic signature. In response to this request, the signature generation server 200 generates a CE number, and generates an electronic signature by using the generated CE number and the user ID transmitted from the terminal device 100.

The client UI software 132 acquires the electronic signature generated by the signature generation server 200 in the manner described above. At this time, the client UI software 132 acquires the CE number generated by the signature generation server 200. Then, the client UI software 132 performs the new contact search for the acquired CE number, and checks the uniqueness of the acquired CE number. In a case the uniqueness is confirmed, the client UI software 132 registers the acquired CE number in the first auxiliary information, and registers the acquired electronic signature in the first or second auxiliary information. Then, the client UI software 132 records the user ID and the acquired CE number in the storage unit 110 in association with each other.

Heretofore, a functional configuration of the terminal device 100 according to the present embodiment has been described. As described above, although there is a difference to the terminal device 100 according to the first embodiment in that the CE number is acquired from the signature generation server 200, there is substantially no difference to the process relating to the registration of the CE number and the electronic signature, the process relating to the uniqueness check for the CE number and the process relating to the cache.

<2-2: Functional Configuration of Signature Generation Server 200>

Next, a functional configuration of the signature generation server 200 according to the present embodiment will be described with reference to FIG. 8. FIG. 8 is an explanatory diagram showing an example of the functional configuration of the signature generation server 200 according to the present embodiment. Note that detailed description of structural elements that have substantially the same function as those of the signature generation server 200 according to the first embodiment described above will be omitted.

As shown win FIG. 8, the signature generation server 200 is mainly configured from a communication unit 202, an IP telephony module 204, a uniqueness check unit 206, a signature generation unit 208, a personal identification unit 210, and a CE number generation unit 232. The main difference to the signature generation server 200 according to the first embodiment described above lies in the presence of the CE number generation unit 232. Accordingly, in the following, a configuration relating to a function of the CE number generation unit 232 will be mainly described.

As described above, the CE number management system 10 of the present embodiment is configured such that the process of generating a CE number is performed by the signature generation server 200. Accordingly, the signature generation server 200 generates the CE number when a signature generation request is received from the terminal device 100. When the signature generation server 200 receives the signature generation request, the CE number is generated by the CE number generation unit 232. Then, the CE number generated by the CE number generation unit 232 is input to the signature generation unit 208. The signature generation unit 202 generates an electronic signature by using a user ID acquired from the terminal device 100 via the communication unit 202 and the CE number that is input. Additionally, in a case a system ID is input from the terminal device 100, the electronic signature is generated based on the user ID, the CE number and the system ID.

Furthermore, the CE number generated by the CE number generation unit 232 is also input to the uniqueness check unit 206. When the CE number is input, the uniqueness check unit 206 performs, by the IP telephony module 204, the new contact search with the input CE number as key information. The uniqueness of the CE number that is input is checked by this new contact search. In a case the uniqueness is confirmed by this check, the electronic signature generated by the signature generation unit 208 is provided to the terminal device 100 together with the CE number. On the other hand, in a case the uniqueness of the CE number that is input is denie, a new CE number is generated by the CE number generation unit 232, and a new electronic signature is generated by the signature generation unit 208. Then, the uniqueness is checked by the uniqueness check unit 206 for the new CE number.

Heretofore, a functional configuration of the signature generation server 200 according to the present embodiment has been described. As described above, although there is a difference to the first embodiment in that the CE number is generated by the CE number generation unit 232, there is substantially no difference to the process relating to the generation of the electronic signature, the process relating to the uniqueness check, the process relating to the personal identification, and the like.

<2-3: Registration Sequence>

Next, a processing sequence performed at the time of registration of a CE number (and an electronic signature) at the CE number management system 10 according to the present embodiment will be described with reference to FIG. 9. FIG. 9 is an explanatory diagram showing a processing sequence performed at the time of registration of a CE number (and an electronic signature) at the CE number management system 10 of the present embodiment.

As shown in FIG. 9, first, the client UI software 132 is started by a user, and a user ID and a password are input. When the user ID and the password are input, the client UI software 132 signs in to the IP telephony system 14 via the IP telephony module 106 (S202). On the other hand, the signature generation server 200 also signs in to the IP telephony system 14 via the IP telephony module 204 (S204). When the sign-ins are complete, the client UI software 132 transmits, to the signature generation server 200, the user ID (and a system ID), and requests for the generation of a signature (S206).

When this request is received, the signature generation server 200 performs, by using the received user ID, personal identification via the IP telephony modules 106 and 204 (S208, S210). At this time, an inquiry of whether signature generation is requested or not is notified from the signature generation server 200 to the terminal device 100 (the client UI software 132) via the IP telephony system 14 (by AP2AP).

When this inquiry is received, the client UI software 132 sends back, to the signature generation server 200, a response to the inquiry via the IP telephony system 14 (S212, S214). In this case, the client UI software 132 has requested for signature generation, and thus a response YES is notified to the signature generation server 200. When this response is received, the signature generation server 200 generates a CE number (S216). Then, the signature generation server 200 performs the new contact search with the generated CE number as key information by using the IP telephony module 204 (S218). The uniqueness of the CE number is checked by this new contact search.

When the uniqueness of the CE number is confirmed by the process of step S218, the signature generation server 200 generates an electronic signature by using the previously acquired user ID (and the system ID) and the generated CE number (S220). Then, the signature generation server 200 transmits the generated electronic signature and the CE number to the client UI software 132 together with the check result for the uniqueness (S222). Additionally, in a case the uniqueness of the CE number is not confirmed by the process of step S218, the signature generation server 200 returns to the process of step S216, generates a new CE number, and performs the processes of steps S218 and S220. Here, it is assumed that the uniqueness is confirmed.

When the CE number is received, the client UI software 132 registers the received CE number in the first auxiliary information (S224). For example, the client UI software 132 writes the CE number in a real name field corresponding to the part of the first auxiliary information. Furthermore, when the electronic signature is received, the client UI software 132 registers the received electronic signature in the first or second auxiliary information (S226). For example, the client UI software 132 writes the electronic signature in a comment field corresponding to the part of the second auxiliary information. Then, the client UI software 132 performs the new contact search with the CE number as key information, and checks the uniqueness of the CE number (S228). In a case the uniqueness of the CE number is not confirmed here, the client UI software 132 again performs the process of step S206 and subsequent processes.

Heretofore, a processing sequence of the CE number management system 10 relating to the registration of the CE number or the like has been described.

<3: Hardware Configuration>

The function of each structural element of the terminal device 100 and the signature generation server 200 described above can be realised by using the hardware configuration of an information processing apparatus shown in FIG. 10, for example. That is, the function of each of the structural elements is realised by controlling the hardware shown in FIG. 10 by using a computer program. Additionally, the mode of this hardware is arbitrary, and may be a personal computer, a mobile information terminal such as a mobile phone, a PHS or a PDA, a game machine, or various types of information appliances. Moreover, the PHS is an abbreviation for Personal Handy-phone System. Also, the PDA is an abbreviation for Personal Digital Assistant.

As shown in FIG. 10, this hardware mainly includes a CPU 902, a ROM 904, a RAM 906, a host bus 908, and a bridge 910. Furthermore, this hardware includes an external bus 912, an interface 914, an input unit 916, an output unit 918, a storage unit 920, a drive 922, a connection port 924, and a communication unit 926. Moreover, the CPU is an abbreviation for Central Processing Unit. Also, the ROM is an abbreviation for Read Only Memory. Furthermore, the RAM is an abbreviation for Random Access Memory.

The CPU 902 functions as an arithmetic processing unit or a control unit, for example, and controls entire operation or a part of the operation of each structural element based on various programs recorded on the ROM 904, the RAM 906, the storage unit 920, or a removal recording medium 928. The ROM 904 is means for storing, for example, a program to be loaded on the CPU 902 or data or the like used in an arithmetic operation. The RAM 906 temporarily or perpetually stores, for example, a program to be loaded on the CPU 902 or various parameters or the like arbitrarily changed in execution of the program.

These structural elements are connected to each other by, for example, the host bus 908 capable of performing high-speed data transmission. For its part, the host bus 908 is connected through the bridge 910 to the external bus 912 whose data transmission speed is relatively low, for example. Furthermore, the input unit 916 is, for example, a mouse, a keyboard, a touch panel, a button, a switch, or a lever. Also, the input unit 916 may be a remote control that can transmit a control signal by using an infrared ray or other radio waves.

The output unit 918 is, for example, a display device such as a CRT, an LCD, a PDP or an ELD, an audio output device such as a speaker or headphones, a printer, a mobile phone, or a facsimile, that can visually or auditorily notify a user of acquired information. Moreover, the CRT is an abbreviation for Cathode Ray Tube. The LCD is an abbreviation for Liquid Crystal Display. The PDP is an abbreviation for Plasma Display Panel. Also, the ELD is an abbreviation for Electro-Luminescence Display.

The storage unit 920 is a device for storing various data. The storage unit 920 is, for example, a magnetic storage device such as a hard disk drive (HDD), a semiconductor storage device, an optical storage device, or a magneto-optical storage device. The HDD is an abbreviation for Hard Disk Drive.

The drive 922 is a device that reads information recorded on the removal recording medium 928 such as a magnetic disk, an optical disk, a magneto-optical disk or a semiconductor memory, or writes information in the removal recording medium 928. The removal recording medium 928 is, for example, a DVD medium, a Blu-ray medium, an HD-DVD medium, various types of semiconductor storage media, or the like. Of course, the removal recording medium 928 may be, for example, an electronic device or an IC card on which a non-contact IC chip is mounted. The IC is an abbreviation for Integrated Circuit.

The connection port 924 is a port such as an USB port, an IEEE1394 port, a SCSI, an RS-232C port, or a port for connecting an externally connected device 930 such as an optical audio terminal. The externally connected device 930 is, for example, a printer, a mobile music player, a digital camera, a digital video camera, or an IC recorder. Moreover, the USB is an abbreviation for Universal Serial Bus. Also, the SCSI is an abbreviation for Small Computer System Interface.

The communication unit 926 is a communication device to be connected to a network 932, and is, for example, a communication card for a wired or wireless LAN, Bluetooth (registered trademark), or WUSB, an optical communication router, an ADSL router, or various communication modems. The network 932 connected to the communication unit 926 is configured from a wire-connected or wirelessly connected network, and is the Internet, a home-use LAN, infrared communication, visible light communication, broadcasting, or satellite communication, for example. Moreover, the LAN is an abbreviation for Local Area Network. Also, the WUSB is an abbreviation for Wireless USB. Furthermore, the ADSL is an abbreviation for Asymmetric Digital Subscriber Line.

<4: Summary>

Lastly, the technical contents according to the embodiment of the present invention will be briefly described. The technical contents stated here can be applied to various information processing apparatuses, such as a digital television, a PC, a mobile phone, a portable game machine, a portable information terminal, an information appliance, a car navigation system, and the like. Particularly, the technical contents is expected to bring about a significant effect by being applied to an information processing apparatus not provided with a full keyboard.

The functional configuration of the information processing apparatus described above can be expressed as follows. The information processing apparatus includes a simple ID registration unit that registers, in first auxiliary information which is managed in association with a user ID for specifying an individual user and which is made a search target at a time of searching for the user ID, a simple ID expressed by a combination of numbers or of a number and a specific symbol, and a signature registration unit that registers, in second auxiliary information which is managed in association with the first auxiliary information or the use ID and which is not made the search target, an electronic signature obtained, by using a signature key, from ID information including the user ID and the simple ID.

As described above, the simple ID is expressed by a combination of numbers or of a number and a specific symbol. For example, the simple ID is expressed by combining a number and a specific symbol that can be easily input by a remote control. Furthermore, according to the configuration described above, this simple ID is registered in the first auxiliary information. This first auxiliary information is information which is made a search target at the time of searching for a user ID. Accordingly, by registering the simple ID in the first auxiliary information, a user ID can be searched for with the simple ID as key information. That is, a user ID can be searched for by using a simple ID that can be easily input by an input device such as a remote control.

Furthermore, according to the configuration described above, the electronic signature is registered in the first auxiliary information or the second auxiliary information. This electronic signature is generated for a pair of a user ID and a simple ID. Accordingly, by performing signature verification by using this electronic signature, validity regarding the combination of the user ID and the simple ID can be checked. There is a possibility that multiple user IDs are detected in a case a search is performed with the simple ID as key information. For example, there may be registered in the first auxiliary information a character sequence that includes the simple ID by chance. In such case, a user ID corresponding to this first auxiliary information is also included in the result of the search.

However, by performing signature verification in the manner described above and extracting a user ID for which the signature verification is achieved, a correct user ID corresponding to the simple ID can be detected. Of course, by managing, separately from the user ID, the simple ID in a database, uniqueness of a combination of the user ID and the simple ID might be guaranteed. However, managing the simple ID by operating such database at all times incurs additional cost. Also, it is extremely important, from the standpoint of effective usage of existing infrastructure, that the simple ID can be managed without changing the mechanism of an existing IP telephony system.

In the case of the embodiment described above, it is enough that the simple ID and the electronic signature are registered in auxiliary information that is used by an existing IP telephony system, and thus the mechanism of the existing IP telephony system does not have to be changed. Furthermore, since the electronic signature is used to extract a correct combination of the simple ID and the user ID, resistance to alteration of the simple ID or the like is high. Furthermore, a search based on the simple ID can be performed on the side of the IP telephony system or can be performed on the local side, and thus high flexibility can be achieved for the system configuration. As described, by applying the configuration of the embodiment described above, various effects can be obtained, such as improvement in the convenience of a user, reduction in the cost, and improvement in the security.

(Remarks)

The client UI software 104 and 132 are examples of the simple ID registration unit, the signature registration unit, a uniqueness check unit, a signature verification unit and a user ID extraction unit. The client UI software 104 and 132 and the IP telephony module 106 are examples of a user information acquisition unit. The client UI software 104 and 132 and the storage unit 110 are examples of an ID information holding unit. The CE number is an example of the simple ID. The communication unit 202 is an example of the ID information acquisition unit and a signature providing unit. The CE number management system 10 is an example of a simple ID management system.

<5: Supplement>

In the following, concrete examples of the method of generating a CE number, the signature generation method, the new contact search and the signature verification method of the present embodiment will be described.

<Concrete Example of CE Number Generation Method>

Here, a concrete example of a method of generating a CE number by using a one-way function (SHA-1 hash) will be shown.

(Command Execution Example 1)

001| hoge>echo bravia_aaa_bbb_{—}001>tmp1.txt

002| hoge>sh1sum tmp1.txt>tmp.sha1

003| hoge>cat tmp.sha1

004| e300dfab53f7e5565013eabca0cbebb2105a084d tmp1.txt

The “sha1sum” described in line 002 is a command for generating a SHA-1 hash value. In the example above, a hash value is generated in line 002 and is stored in a tmp.sha1 file. The contents of “tmp.sha1” are as shown in line 004. The following number sequence is obtained by decimalising the contents of line 004.

1295 96038 93166 72170 50081 33208 50923 42943 64932 69069

For example, when the last ten digits, in reverse order, of the number sequence are set to be the CE number, the CE number will be the following number sequence. Here, a hyphen is inserted from the standpoint of visibility.

96096-23946

If the uniqueness of the above CE number is denied, next ten digits can be set as the CE number, for example. In this example, the following number sequence can be obtained by extracting the next ten digits.

34924-32905

(Command Execution Example 2)

In the same manner, when the following commands (lines 001 to 003) are executed, the output of line 004 below is obtained.

001| hoge>echo bravia_aaa_bbb_{—}002>tmp2.txt

002| hoge>sh1sum tmp2.txt>tmp.sha1

003| hoge>cat tmp.sha1

004| e1881df620cd9cde75f5e3b3e768a0c26e09c507 tmp2.txt

The following number sequence is obtained by decimalising the output of line 004.

1287 55843 47917 21239 69989 51979 67640 97295 52310 44871

When ten digits are selected in reverse order from the end of the above number sequence, “17844-01325” is obtained, and when the next ten digits are selected, “59279-04676” is obtained.

<Concrete Example of Signature Generation Method>

As an algorithm for private key signature, “sha1RSA” or the like used for an X.509 certificate can be used. In a case a user ID and numbers combine to about 40 characters, a hash such as sha1 may be omitted. If a signature is about 512-bit long, it can be adequately recorded in the second auxiliary information (for example, a comment field). In the following, a method of attaching an rsa signature by using an openss1 command and without using a hash will be described. This method is performed in the following order.

(1) Random Data Generation

$openss1 dgst*>/rand.dat

(2) Private Key Geenration

$openss1 genrsa -rand rand.dat -out honjo.key

(3) Public Key Generation

$openss1 rsa -in honjo.key -pubout -out honjo_p.key

(4) Storing of Original Data in File

$echo “*CE*,Skype0,bravia_aaa_bbb_{—}001,96096-23946,*CE*”>ppp.txt

(5) Signature Data Generation

$openss1 rsaut1 -sign -in ppp.txt -inkey honjo.key -out sign.txt

(6) Conversion from Binary to Text

$base64 sign.txt

yPR56krj0xRq6/INyA1RKq1EC3KQpwXJQLQ7xJeqA8oqrVmFFKrwSSiX6DqYto Gaa6ZOZF5P3V15N5kcf3KDKw==

(7) Registration in Comment Field (Registration of Following Contents)

*CE*

96096-23946

*CE*

yPR56krj0xRq6/INyA1RKq1EC3KQpwXJQLQ7xJeqA8oqrVmFFKrwSSiX6DqYto Gaa6ZOZF5P3V15N5kcf3KDKw==

<Concrete Example of New Contact Search>

A public API of SKP regarding the new contact search includes an API for acquiring a list of user IDs including, in auxiliary information, a character string specified by a user, an API for acquiring specific auxiliary information attached to a specified user ID, or the like. For example, to acquire the contents of a comment field, a command as follows may be executed.

->SEARCH USERS *CE*96096-23946*CE*

<-USERS user123, bravia2885

->GET USER user123 ABOUT

<-USER user123 ABOUT *CE*[CR]96096-23946[CR]*CE*[CR]yPR56krj0xRq6/INyA1RKq1EC3KQpwXJQLQ7xJeqA8oqrV mFFKrwSSiX6DqYtoGaa6ZOZF5P3V15N5kcf3KDKw==

<Concrete Example of Signature Verification Method>

When verifying a signature, a line following the second “*CE*” till the end are extracted from a comment field by the following command.

$echo

yPR56krj0xRq6/INyA1RKq1EC3KQpwXJQLQ7xJeqA8oqrVmFFKrwSSiX6DqYto Gaa6ZOZF5P3V15N5kcf3KDKw==>sign.base64

$base64 --decode sign.base64 >sign.bin

Next, verification of a signed data file (sign.bin) and extraction of original data (bbb) are performed by using a public key (hoge_p.key).

$openss1 rsaut1 -in sign.bin -out bbb -inkey hoge_p.key -verify -pubin

$cat bbb

*CE*,Skype0,bravia_aaa_bbb001,96096-23946,*CE*

If the “sign.bin” is altered, an error as below is output, and original data (bbb) is not generated. An alteration is detected in this manner.

openss1 rsaut1 -in sign.bin -out bbb -inkey hoge_p.key -verify -pubin RSA operation error

15025:error:0407006A:rsa routines:RSA_padding_check_PKCS1_type_{—}1:block type is not 01:rsa_pk1.c:100:

15025:error:04067072:rsa routines:RSA_EAY_PUBLIC_DECRYPT:padding check failed:rsa_eay.c:708:

It should be understood by those skilled in the art that various modifications, combinations, sub-combinations and alterations may occur depending on design requirements and other factors insofar as they are within the scope of the appended claims or the equivalents thereof.

In the explanation of the above embodiment, a configuration is assumed where all communication is performed via an IP telephony module. However, the configuration can be modified such that communication between the terminal device 100 and the signature generation server 200, such as transmission/reception of an electronic signature, is performed without the IP telephony module in between. In this case, data such as an electronic signature is directly transmitted/received via the communication units 108 and 202.

The present application contains subject matter related to that disclosed in Japanese Priority Patent Application JP 2009-235469 filed in the Japan Patent Office on Oct. 9, 2009, the entire content of which is hereby incorporated by reference.

What is claimed is:

1. A terminal device comprising:
a simple ID registration unit that registers, in first auxiliary information which is managed in association with a user ID for specifying an individual user and which is made a search target at a time of searching for the user ID, a simple ID expressed by a combination of numbers or of a number and a specific symbol; and
a signature registration unit that registers, in second auxiliary information which is managed in association with the first auxiliary information or the user ID and which is not made the search target, an electronic signature obtained, by using a signature key, from ID information including the user ID and the simple ID.

2. The terminal device according to claim 1, further comprising:
a uniqueness check unit that searches for the user ID with the simple ID registered by the simple ID registration unit as key information, and checks the number of user IDs that are detected,
wherein, in a case multiple user IDs are detected as a result of search by the uniqueness check unit, the simple ID registration unit newly registers a different simple ID in the first auxiliary information, and
wherein the signature registration unit registers, in the first or second auxiliary information, an electronic signature obtained, by using the signature key, from ID information including the user ID and the different simple ID.

3. The terminal device according to claim 2, further comprising:
a user information acquisition unit that searches for the user ID with the simple ID input by a user as key information, and acquires the user ID corresponding to the simple ID, the first auxiliary information and the second auxiliary information;
a signature verification unit that verifies validity of a combination of the simple ID and the user ID by using the simple ID used for the search by the user information acquisition unit, the user ID acquired by the user information acquisition unit, the electronic signature included in the first or second auxiliary information acquired by the user information acquisition unit and a verification key corresponding to the signature key; and
a user ID extraction unit that extracts, from at least one user ID acquired by the user information acquisition unit, a user ID whose validity is confirmed by the signature verification unit.

4. The terminal device according to claim 3, wherein the simple ID is determined based on a value obtained by inputting the user ID to a one-way function.

5. The terminal device according to claim 4,
wherein the ID information includes a system ID for specifying a system managing the user ID, and
wherein the signature verification unit verifies validity of a combination of the simple ID, the user ID and the system ID by using the simple ID, the user ID, the electronic signature, the verification key and the system ID.

6. The terminal device according to claim 3, further comprising:
an ID information holding unit that holds, in association with each other, at least one user ID and at least one simple ID which corresponds to the at least one user ID and which is registered by the simple ID registration unit,
wherein, when the simple ID is input by a user, the user information acquisition unit searches, with the at least one user ID and the at least one simple ID held in the ID information holding unit as targets, for a user ID corresponding to the simple ID that is input, and
wherein, in a case the user ID corresponding to the simple ID that is input is not detected among the at least one user ID and the at least one simple ID held in the ID information holding unit, the user information acquisition unit searches, with at least one user ID and at least one simple ID held by an external device as targets, for the user ID corresponding to the simple ID that is input.

7. A signature generation server comprising:
an ID information acquisition unit that acquires, from a terminal device capable of registering a simple ID expressed by a combination of numbers or of a number and a specific symbol in first auxiliary information which is managed in association with a user ID for specifying an individual user and which is made a search target at a time of searching for the user ID, the user ID, the simple ID corresponding to the user ID and a generation request for an electronic signature based on the user ID and the simple ID;
a signature generation unit that generates the electronic signature, by using a signature key, from ID information including the user ID and the simple ID acquired by the ID information acquisition unit; and
a signature providing unit that provides the electronic signature generated by the signature generation unit to the terminal device,
wherein the electronic signature provided by the signature providing unit is managed in association with the first auxiliary information or the user ID and is registered in second auxiliary information which is not made the search target.

8. The signature generation server according to claim 7, further comprising:
a uniqueness check unit that searches for the user ID with the simple ID acquired by the ID information acquisition unit as key information, and checks the number of user IDs that are detected,
wherein, in a case multiple user IDs are detected as a result of search by the uniqueness check unit, the simple ID to be registered in the first auxiliary information is changed.

9. The signature generation server according to claim 8, further comprising a personal identification unit that accesses the terminal device by using the user ID acquired by the ID information acquisition unit and checks whether generation of the electronic signature is requested or not.

10. A simple ID management system comprising:
a terminal device including
a simple ID registration unit that registers, in first auxiliary information which is managed in association with a user ID for specifying an individual user and which is made a search target at a time of searching for the user ID, a simple ID expressed by a combination of numbers or of a number and a specific symbol,
a signature generation request unit that provides, to a signature generation server, the user ID input by a user, the simple ID registered by the simple ID registration unit in association with the user ID and a generation request for an electronic signature based on the user ID and the simple ID, and
a signature registration unit that registers, in second auxiliary information which is managed in association with the first auxiliary information or the user ID and which is not made the search target, the electronic signature provided by the signature generation server in response to a request from the signature generation request unit; and
the signature generation server including
an ID information acquisition unit that acquires, from the terminal device, the user ID, the simple ID corresponding to the user ID and the generation request for the electronic signature based on the user ID and the simple ID,
a signature generation unit that generates the electronic signature, by using a signature key, from ID information including the user ID and the simple ID acquired by the ID information acquisition unit, and
a signature providing unit that provides the electronic signature generated by the signature generation unit to the terminal device.

11. A simple ID management method comprising the steps of:
registering, in first auxiliary information which is managed in association with a user ID for specifying an individual user and which is made a search target at a time of searching for the user ID, a simple ID expressed by a combination of numbers or of a number and a specific symbol; and
registering, in second auxiliary information which is managed in association with the first auxiliary information or the user ID and which is not made the search target, an electronic signature obtained, by using a signature key, from ID information including the user ID and the simple ID.

12. A simple ID management method comprising the steps of:
acquiring, from a terminal device capable of registering a simple ID expressed by a combination of numbers or of a number and a specific symbol in first auxiliary information which is managed in association with a user ID for specifying an individual user and which is made a search target at a time of searching for the user ID, the user ID, the simple ID corresponding to the user ID and a generation request for an electronic signature based on the user ID and the simple ID;
generating the electronic signature, by using a signature key, from ID information including the user ID and the simple ID acquired in the step of acquiring; and
providing the electronic signature generated in the step of generating to the terminal device,
wherein the electronic signature provided in the step of providing is managed in association with the first auxiliary information or the user ID and is registered in second auxiliary information which is not made the search target.

13. A simple ID management method comprising the steps of:
registering by a terminal device, in first auxiliary information which is managed in association with a user ID for specifying an individual user and which is made a search target at a time of searching for the user ID, a simple ID expressed by a combination of numbers or of a number and a specific symbol;
providing by the terminal device, to a signature generation server, the user ID input by a user, the simple ID registered in the step of registering in association with the user ID and a generation request for an electronic signature based on the user ID and the simple ID;
acquiring by the signature generation server, from the terminal device, the user ID, the simple ID corresponding to the user ID and the generation request for the electronic signature based on the user ID and the simple ID;
generating by the signature generation server the electronic signature from ID information including the user ID and the simple ID acquired in the step of acquiring, by using a signature key;
providing by the signature generation server, to the terminal device, the electronic signature generated in the step of generating; and
registering by the terminal device, in second auxiliary information which is managed in association with the first auxiliary information or the user ID and which is not made the search target, the electronic signature provided by the signature generation server in response to a request of the step of providing by the terminal device.

14. A program for causing a computer to realise:
a simple ID registration function of registering, in first auxiliary information which is managed in association with a user ID for specifying an individual user and which is made a search target at a time of searching for the user ID, a simple ID expressed by a combination of numbers or of a number and a specific symbol; and
a signature registration function of registering, in second auxiliary information which is managed in association with the first auxiliary information or the user ID and which is not made the search target, an electronic signature obtained, by using a signature key, from ID information including the user ID and the simple ID.

15. A program for causing a computer to realise:
an ID information acquisition function of acquiring, from a terminal device capable of registering a simple ID expressed by a combination of numbers or of a number and a specific symbol in first auxiliary information which is managed in association with a user ID for specifying an individual user and which is made a search target at a time of searching for the user ID, the user ID, the simple ID corresponding to the user ID and a generation request for an electronic signature based on the user ID and the simple ID;
a signature generation function of generating the electronic signature, by using a signature key, from ID information including the user ID and the simple ID acquired by the ID information acquisition function; and
a signature providing function of providing to the terminal device the electronic signature that is generated by the signature generation function, so as to be managed in association with the first auxiliary information or the user ID and registered in second auxiliary information which is not made the search target.
